(19) United States
(12) Patent Application Publication
(10) Pub. No.: US 2026/0292352 A1
(43) Pub. Date: Sep. 24, 2026

(54) IMAGE RECOGNITION METHOD, ELECTRONIC DEVICE, AND STORAGE MEDIUM

(71) Applicant: SHENZHEN CHEERBLE TECHNOLOGY CO., LTD., Shenzhen (CN)

(72) Inventors: Weicheng Guo, Shenzhen (CN); Jinbin Xie, Shenzhen (CN)

(21) Appl. No.: 19/685,471

(22) Filed: May 22, 2026

Related U.S. Application Data
(63) Continuation-in-part of application No. PCT/CN2026/088415, filed on Apr. 2, 2026.

(30) Foreign Application Priority Data
Sep. 18, 2025 (CN) 202511343938.8

(51) Int. Cl. H04N 23/72; G06V 40/10; H04N 23/11; H04N 23/61; H04N 23/71; H04N 23/73; H04N 23/74; H04N 23/76

(52) U.S. Cl. CPC H04N 23/72; G06V 40/10; H04N 23/11; H04N 23/61; H04N 23/71; H04N 23/73; H04N 23/74; H04N 23/76

(57) ABSTRACT

An image recognition method is provided. The image recognition method includes turning on an infrared light of the recognition device. An response to a determination that an ambient light intensity of an object to be recognized is changed in a first direction, an intensity of infrared light emitted by the infrared light is controlled to change in the first direction, an exposure parameter of the recognition device is controlled to change in a second direction, a grayscale of an object face in an object image captured by the recognition device is maintained within a first grayscale range, and an average background grayscale of the object image is maintained within a second grayscale range. The object to be recognized is recognized from the object image. An electronic device and a storage device are also provided.

### FIELD

The present application relates to a field of image recognition, and in particular, to an image recognition method, an electronic device and a storage medium.

### BACKGROUND

With socio-economic development and the application of intelligent products, people pursue spiritual satisfaction and enjoy companionship of pets such as a cat and a dog. The demand for pets is increasing day by day, and pet product market is relatively large. At the same time, people's awareness of scientific pet raising is gradually increasing, seeking a healthy and reasonable pet life and avoiding irregularities in pet raising caused by insufficient time and energy. Image recognition technology may be used to recognize a pet's face, ensuring that only a specific pet may access food, preventing other pets from grabbing food; it may also be applied to a pet door, ensuring that a specific pet may freely enter and exit, preventing other pets from entering by mistake; or it may be applied to other device requiring pet recognition, such as a pet water fountain and a pet toilet.

Image recognition technology uses full-color images to recognize the pet during the day and infrared images to recognize the pet at night. During the day or under sufficient light, the quality of full-color images is higher, while at night or under insufficient light, infrared images are relatively clearer.

However, in current image recognition, besides the pet, the background in captured full-color images and infrared images may include clearly visible elements such as room layouts and people moving around, posing a risk of privacy leakage.

### SUMMARY

In view of the above, it is necessary to provide an image recognition method, an electronic device and a storage medium.

In a first aspect, the present application provides an image recognition method applied in a an electronic, which includes an infrared light and a camera. The image recognition method includes: turning on the infrared light; in response to a determination that an ambient light intensity of an object to be recognized is changed in a first direction, controlling an intensity of infrared light emitted by the infrared light to change in the first direction, controlling an exposure parameter of the camera to change in a second direction, maintaining a grayscale of an object face in an object image captured by the camera within a first grayscale range, and maintaining an average background grayscale of the object image within a second grayscale range, wherein the second direction is opposite to the first direction, and grayscales of the second grayscale range beingless than a lower limit of a preset grayscale threshold recognizable by human eyes; and recognizing the object to be recognized from the object image.

In some embodiments of the present application, where the exposure parameter comprises exposure time, in response to a determination that the ambient light intensity of the object to be recognized is changed in the first direction, controlling the intensity of infrared light emitted by the infrared light to change in the first direction, and controlling the exposure parameter of the camera to change in the second direction includes: in response to a determination that the ambient light intensity of the object to be recognized has increased, increasing the intensity of the infrared light emitted by the infrared light, and decreasing the exposure time of the camera; and in response to a determination that the ambient light intensity of the object to be recognized has decreased, decreasing the intensity of the infrared light emitted by the infrared light, and increasing the exposure time of the camera.

In some embodiments of the present application, where in response to the ambient light intensity of the object to be recognized increasing, increasing the intensity of the infrared light emitted by the infrared light, and decreasing the exposure time of the camera includes: in response to an identification that the average background grayscale has increased to a first value due to an increase of the ambient light intensity of the object to be recognized, turning on an image signal processing dynamic mode; in the image signal processing dynamic mode, increasing the intensity of the infrared light by a first percentage, and decreasing the exposure time by a second percentage, until the average background grayscale is in a range between a second value and the first value, wherein the second value is less than the first value, and the second grayscale value range comprises the first value and the second value; and continuing adjusting the intensity of the infrared light and keeping the grayscale of the object face being within the first grayscale value range.

In some embodiments of the present application, where the first value is 50, the second value is 10, and the first grayscale value range is [110, 160].

In some embodiments of the present application, where the first value is 20, the second value is 10, and the first grayscale value range is [110, 160].

In some embodiments of the present application, where in response to a determination that the ambient light intensity of the object to be recognized has decreased, decreasing the intensity of the infrared light emitted by the infrared light, and increasing the exposure time of the camera includes: in response to a determination that the average background grayscale value of the object image has decreased to the second value due to a decrease of the ambient light intensity of the object to be recognized after the image signal processing dynamic mode is turned on, increasing the exposure time by the first percentage, and decreasing the intensity of the infrared light by the second percentage, where the average background grayscale is between the second value and the first value.

In some embodiments of the present application, where in response to a determination that the ambient light intensity of the object to be recognized has decreased, after decreasing the intensity of the infrared light emitted by the infrared light, and increasing the exposure time of the camera, the method further comprises: in response to a determination that the intensity of the infrared light has decreased to less than a calibrated infrared light intensity, restoring the exposure time to calibrated exposure time, and restoring the intensity of the infrared light to the calibrated infrared light intensity.

In some embodiments of the present application, where the calibrated infrared light intensity is preset by: setting an image signal processing gain to a predetermined image signal processing gain and setting the exposure time to the calibrated exposure time under a condition that the ambient light intensity is zero; and adjusting the intensity of the infrared light to make the average background grayscale of the object image be less than the second value, and the grayscale of the object face is within a third grayscale value range, wherein the third grayscale value range comprises the first grayscale value range.

In some embodiments of the present application, where the predetermined image signal processing gain is 1, the calibrated exposure time is 1 ms, the third grayscale value range is [90, 180], and the first grayscale value range is [110, 160].

In some embodiments of the present application, where before recognizing the object to be recognized from the object image, the method further includes: in response to a determination that the ambient light intensity has exceeded a preset light intensity threshold, setting a foreground region and a background region in the object image, wherein the foreground region comprises an image of the object face of the object to be recognized; and performing a blurring processing on the background region of the object image and obtaining a blurred object image; where recognizing the object to be recognized from the object image includes: recognizing the object to be recognized from the blurred object image.

In some embodiments of the present application, where performing a blurring processing on the background region of the object image and obtaining the blurred object image includes: performing a blurring adjustment of image parameters on the background region of the object image and obtaining the blurred object image, wherein the image parameters comprise at least one of: a de-texturing, a down-sampling, a blur kernel, a contrast, a quantization bit width, a dynamic range compression, a privacy mask, an occlusion, a tone mapping, a gamma, sharpness, and a noise reduction.

In some embodiments of the present application, where performing a blurring processing on the background region of the object image and obtaining the blurred object image includes: performing a blurring processing on the background region of the object image using at least one of: a variable aperture, a switchable or continuously adjustable neutral density filter, a controllable defocus element, and polarization control, and obtaining the blurred object image.

In some embodiments of the present application, where after recognizing the object to be recognized from the object image, the method further includes: saving a sequence of object images of the object to be recognized into a server.

In a second aspect, the present application provides an electronic device, including: an infrared light; a camera; a storage device; at least one processor; and the storage device storing one or more programs that, when executed by the at least one processor, cause the at least one processor to: turn on the infrared light; in response to a determination that an ambient light intensity of an object to be recognized is changed in a first direction, control an intensity of infrared light emitted by the infrared light to change in the first direction, control an exposure parameter of the camera to change in a second direction, maintain a grayscale of an object face in an object image captured by the camera within a first grayscale range, and maintain an average background grayscale of the object image within a second grayscale range, wherein the second direction is opposite to the first direction, and grayscales of the second grayscale range beingless than a lower limit of a preset grayscale threshold recognizable by human eyes; and recognize the object to be recognized from the object image.

In a third aspect, the present application provides a non-transitory storage medium having instructions stored thereon, when the instructions are executed by a processor of an electronic device, the electronic device includes an infrared light and a camera, the processor is caused to perform an image recognition method, wherein the image recognition method includes: turning on an infrared light; in response to a determination that an ambient light intensity of an object to be recognized is changed in a first direction, controlling an intensity of infrared light emitted by the infrared light to change in the first direction, controlling an exposure parameter of the camera to change in a second direction, maintaining a grayscale of an object face in an object image captured by the camera within a first grayscale range, and maintaining an average background grayscale of the object image within a second grayscale range, wherein the second direction is opposite to the first direction, and grayscales of the second grayscale range beingless than a lower limit of a preset grayscale threshold recognizable by human eyes; and recognizing the object to be recognized from the object image.

### BRIEF DESCRIPTION OF THE DRAWINGS

FIG. 1 is a schematic flowchart of an image recognition method according to an embodiment of the present application.

FIG. 2 is a schematic diagram of an object image according to an embodiment of the present application.

FIG. 3 is a schematic flowchart of step 102 in FIG. 1.

FIG. 4 is a schematic flowchart of step 301 in FIG. 3.

FIG. 5 is a schematic flowchart of presetting a calibrated infrared light intensity according to an embodiment of the present application.

FIG. 6 is a schematic flowchart of object image recognition according to an embodiment of the present application.

FIG. 7 is a schematic structural diagram of an image recognition apparatus according to an embodiment of the present application.

FIG. 8 is a schematic structural diagram of an electronic device according to an embodiment of the present application.

### DETAILED DESCRIPTION

To make the objectives, technical solutions, and advantages of the present application clearer, the following further describes the present application in detail with reference to the accompanying drawings and embodiments. It should be understood that the specific embodiments described herein are only used to explain the present application and are not intended to limit the present application.

It should be noted that although functional module divisions are shown in the apparatus schematic diagrams and logical sequences are shown in the flowcharts, in some cases, steps shown or described may be performed in a different order than the module divisions in the apparatus or the sequences in the flowcharts. The terms “first”, “second”, etc. in the specification and claims and the above-mentioned drawings are used to distinguish similar objects and are not necessarily used to describe a specific order or sequence.

The word “exemplary” is used exclusively herein to mean “serving as an example, instance, or illustration.” Any embodiment described herein as “exemplary” is not necessarily to be construed as preferred or advantageous over other embodiments.

In the embodiments of the present application, the term “module” or “unit” refers to a computer program or part of a computer program having a predetermined function, working together with other related parts to achieve a predetermined goal, and may be implemented in whole or in part by using software, hardware (such as processing circuits or memory), or a combination thereof. Similarly, one processor (or multiple processors or memories) may be used to implement one or more modules or units. Furthermore, each module or unit may be an integral module or unit that includes the functionality of that module or unit.

Additionally, to better illustrate the present application, numerous specific details are set forth in the detailed description below. Those skilled in the art will appreciate that the present application may be practiced without some of these specific details. In some instances, methods, means, elements, and circuits well known to those skilled in the art are not described in detail to highlight the gist of the present application.

Unless defined otherwise, all technical and scientific terms used herein have the same meaning as commonly understood by one of ordinary skill in the art to which this application belongs. The terms used herein are for the purpose of describing embodiments of the present application only and are not intended to limit the present application.

With socio-economic development and the application of intelligent products, people pursue spiritual satisfaction and enjoy companionship of pets such as a cat and a dog. The demand for pets is increasing day by day, and pet product market is relatively large. At the same time, people's awareness of scientific pet raising is gradually increasing, seeking a healthy and reasonable pet life and avoiding irregularities in pet raising caused by insufficient time and energy. Image recognition technology may be used to recognize a pet's face, ensuring that only a specific pet may access food, preventing other pets from grabbing food; it may also be applied to a pet door, ensuring that a specific pet may freely enter and exit, preventing other pets from entering by mistake; or it may be applied to other device requiring pet recognition, such as a pet water fountain and a pet toilet.

Currently, cameras do not require infrared image recognition during the day with sufficient light. When light is dim or insufficient, infrared image recognition or full-color image fill light needs to be used. Under different light intensities, there will be color deviations between daytime full-color images and nighttime infrared images or nighttime full-color images, leading to inconsistencies between the captured image and the image in the recognition database, affecting recognition accuracy and efficiency. Especially in pet recognition, when infrared images of pets or full-color images with fill light are used at night, the difference from the full-color images used during the day is significant, leading to inaccurate recognition or recognition errors. If fill light is suddenly applied at night, it can also cause discomfort for the pet and the pet owner. Moreover, in current image recognition, besides the pet, the background in captured full-color images and infrared images may include clearly visible elements such as room layouts and people moving around, posing a risk of privacy leakage.

In this regard, embodiments of the present application provide an image recognition method that can solve the above technical problems.

The image recognition method provided by the embodiments of the present application is described below.

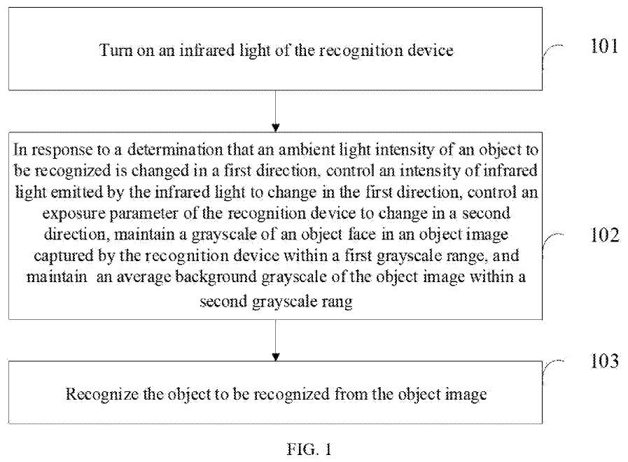

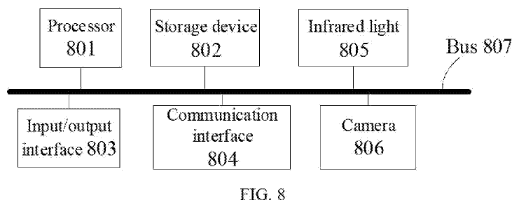

Referring to FIG. 1, in some embodiments, the image recognition method provided by the embodiments of the present application is used for a recognition device having an infrared light and a camera, where a filter wavelength range of the camera includes an infrared wavelength range. For example, the recognition device is an electronic device as shown in FIG. 8. The method may include, but is not limited to, steps 101 to 103.
Step 101: the infrared light is turned on.
Step 102: In response to an ambient light intensity of an object to be recognized changing in a first direction, an intensity of infrared light emitted by the infrared light is controlled to change in the first direction, and an exposure parameter of the recognition device is controlled to change in a second direction, and a grayscale of an object face of an object image captured by the recognition device is maintained within a first grayscale range, and an average background grayscale of the object image is maintained within a second grayscale range, where the second direction is opposite to the first direction, and grayscales in the second grayscale range are less than a lower limit of a preset grayscale threshold recognizable by human eyes.
Step 103: the object to be recognized is recognized from the object image.

In steps 101 to 103 illustrated in the embodiments of the present application, during the process of capturing the object to be recognized based on the camera, as the ambient light intensity at the location of the object to be recognized changes in the first direction, the exposure parameter of the recognition device is adjusted to change in the opposite second direction, while the intensity of the infrared light emitted by the infrared light is adjusted to change in the first direction. This maintains the grayscale of the object's face in the captured image of the object to be recognized within the first grayscale range. That is, regardless of whether the environment where the object is located is day or night, and regardless of the difference in ambient light, the grayscale of the face in the captured image is within a preset grayscale range, ensuring small differences in images captured under different lighting conditions, accurately capturing the detailed features of the face of the object to be recognized, thereby improving the stability and reliability of the recognition system. Furthermore, the average background grayscale of the captured image is maintained within a second grayscale range that is less than the lower limit of the preset grayscale threshold recognizable by human eyes. This avoids the influence of background light on imaging. The imaging of facial features relies on infrared light capture, further reducing imaging differences under different lighting conditions. Moreover, since the average background grayscale is unrecognizable to human eyes, exposure of background elements is avoided, reducing the risk of privacy leakage.

In step 101 of some embodiments, the camera here may be an active infrared camera. The camera emits infrared light through an infrared light. The infrared light illuminates the target object and is reflected. The reflected infrared light is received by the camera's sensor and converted into an image signal, thereby achieving imaging. The camera may be equipped with a narrow-band (850 nm range or 940 nm range, bandwidth 30 nm) lens. The lens only captures infrared light of this single frequency. That is, when there is visible light in the environment, the lens on the camera filters out most bands of light, allowing only light in the (850 nm or 940 nm) band to enter the camera for imaging. This may effectively reduce ambient light interference, ensuring accurate capture of the pet's facial details under different lighting conditions, thereby improving the stability and reliability of the recognition system.

Here, the infrared light may be turned on only when an animal is detected passing by. For example, the recognition device may also use a passive infrared sensor to detect changes in infrared radiation emitted by an object (such as a pet) to determine whether a moving object is passing by. When an object enters the detection area of the passive infrared sensor, the sensor may detect the change in infrared radiation, thereby triggering the camera's infrared light to turn on. In addition to the passive infrared sensor, the camera may also be equipped with an image processing-based motion detection algorithm. By analyzing image data in real time, when a change in the image (such as a pet passing by) is detected, the infrared light is automatically turned on. The following description uses the passive infrared sensor as an example. It may be understood that the infrared light here may be a single infrared light or an infrared light group including multiple infrared lights. That is, changing the intensity of infrared light emitted by the infrared light in the first direction refers to adjusting the infrared light intensity of each infrared light in the infrared light group to change in the first direction.

In step 102 of some embodiments, the object to be recognized may refer to an object captured by the camera, and here it may be an animal entering the detection area of the passive infrared sensor.

Ambient light intensity may refer to the intensity of natural light in the environment where the object to be recognized is located. Changes in ambient light intensity will directly affect image quality. The recognition of ambient light intensity may be based on the analysis result of the captured image or may be detected by a light sensor (such as a photoresistor or photodiode).

Exposure parameters may refer to a set of settings used to control image brightness and quality during photography or videography. These parameters mainly include exposure time (shutter speed), aperture size, and International Organization for Standardization (ISO) sensitivity. By adjusting these parameters, the amount of light entering the camera sensor may be controlled, thereby affecting the brightness, contrast, and detail representation of the image.

Object face grayscale may refer to the numerical value obtained by quantifying the average pixel brightness of the face region of the object to be recognized during image processing. The grayscale is typically an integer between 0 and 255, where 0 represents completely black, 255 represents completely white, and intermediate values represent different shades of gray.

Average background grayscale may refer to the numerical value obtained by quantifying the pixel brightness of the background region of the image of the object to be recognized during image processing.

It may be understood that when the ambient light intensity of the object to be recognized changes in the first direction, the grayscale of the object's face and the average background grayscale in the captured object image will also change in the first direction. Here, the exposure parameter may be adjusted to change in the second direction, which is opposite to the first direction, to adjust the background brightness so that the average background grayscale is within the second grayscale range, which is less than the lower limit of the preset grayscale threshold recognizable by human eyes. That is, the background objects or other sensitive information in the adjusted image may not be recognized by human eyes.

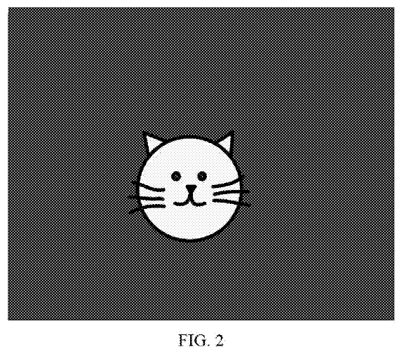

Since adjusting the exposure parameter also affects the grayscale of the object's face, the intensity of the infrared light (an adjustment methods may include a current/voltage modulation, a Pulse Width Modulation (PWM) duty cycle, a light group grouping/phase rotation) may also be adjusted here to maintain the grayscale of the object's face within the first grayscale range. The lower limit of the preset grayscale threshold recognizable by human eyes may be the lowest grayscale at which human eyes may recognize information in an image. The background grayscale cannot be directly recognized by human eyes, or the detail intensity of the background region is insufficient for human eyes to resolve (the detail intensity includes but is not limited to any metric of edges/texture/high-frequency components/information content), or the background exhibits saturation distortion (e.g., underexposure causing details to be indistinguishable). Exemplarily, referring to the schematic diagram of an object image shown in FIG. 2, the object to be recognized in the figure is exemplified only by the face, and the body part is not shown in the figure. Only the object to be recognized may be seen in the object image, and background elements may not be recognized. Among them, there may also be elements in the background whose content may not be resolved by human eyes; this is only an example.

It may be understood that based on the average background grayscale being within the second grayscale range, which is less than the lower limit of the preset grayscale threshold recognizable by human eyes, when no living being approaches, the captured image is completely black. Compared with full-color images or conventional infrared image recognition screens that record background conditions, this protects user privacy.

In step 103 of some embodiments, the method for recognizing the object to be recognized from the object image may be based on comparing facial features of the object in the object image with a facial feature library and a recognition result is obtained.

Taking a pet facial feature library as an example, the pet facial feature library may include pre-stored facial features for pets. The extracted facial features may not only include key information such as facial contours and positions of facial features but may also include subtle features such as hair texture and color distribution. The facial features of the object may be compared with the facial features in the pet facial feature library, and the target pet corresponding to the facial features whose feature similarity meets a condition may be used as the recognition result for the object to be recognized. Exemplarily, if the facial features of the object match the facial features in the pet facial feature library, the pet is successfully recognized.

Methods for calculating feature similarity may include Euclidean distance, cosine similarity, and Hamming distance. Among them, the Euclidean distance calculates the straight-line distance between two vectors in space, with smaller values indicating higher similarity. The cosine similarity calculates the cosine of the angle between two vectors, with values closer to 1 indicating higher similarity. Hamming distance is suitable for binary feature vectors and represents the number of positions where the corresponding elements of two vectors differ.

It may be understood that after recognizing the identity of the pet, the recognition device here may also provide a personalized diet plan for the recognized pet to ensure the pet's nutritional balance, etc., which is not limited here.

The image recognition method provided in the present application is used for a recognition device having an infrared light and a camera, where a filter wavelength range of the camera includes an infrared wavelength range. The method includes turning on an infrared light of the recognition device; in response to a determination that an ambient light intensity of an object to be recognized is changed in a first direction, controlling an intensity of infrared light emitted by the infrared light to change in the first direction, controlling an exposure parameter of the recognition device to change in a second direction, maintaining a grayscale of an object face in an object image captured by the recognition device within a first grayscale range, and maintaining an average background grayscale of the object image within a second grayscale range, wherein the second direction is opposite to the first direction, and grayscales of the second grayscale range beingless than a lower limit of a preset grayscale threshold recognizable by human eyes; and recognizing the object to be recognized from the object image.

This method, by changing the intensity of the infrared light in the same direction as the change in ambient light and changing the exposure parameter in the opposite direction while capturing the object to be recognized based on the ambient light change, maintains the grayscale value of the object's face in the captured image within a first grayscale range, while maintaining the average background grayscale value of the captured image within a second grayscale range that is less than the lower limit of the grayscale threshold recognizable by human eyes. This avoids exposure of sensitive background information and reduces the risk of privacy leakage.

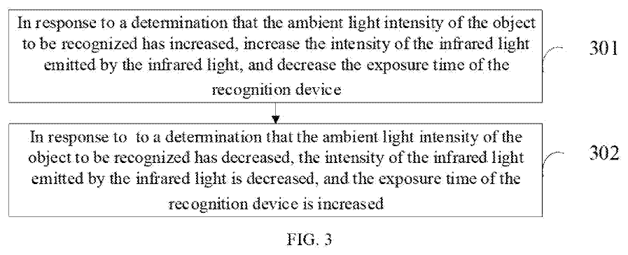

Referring to FIG. 3, in some embodiments, the exposure parameter may include an exposure time, an analog/digital gain, an aperture, a High Dynamic Range (HDR) synthesis threshold, or a readout mode, etc. Taking the exposure parameter as exposure time as an example, step 102 includes but is not limited to including steps 301 to 302.
Step 301: In response to a determination that the ambient light intensity of the object to be recognized has increased, the intensity of the infrared light emitted by the infrared light is increased, and the exposure time of the recognition device is decreased.
Step 302: In response to a determination that the ambient light intensity of the object to be recognized has decreased, the intensity of the infrared light emitted by the infrared light is decreased, and the exposure time of the recognition device is increased.

In this embodiment, when adjusting the exposure parameter of the recognition device, other parameters may be fixed, and only the exposure time, i.e., the length of time the camera sensor is exposed to light, is adjusted.

To ensure images with small differences in imaging under different lighting conditions, the recognition device may automatically adjust the intensity of the infrared light and the exposure time of the recognition device based on changes in ambient light intensity. Specifically, when it is detected that the ambient light intensity of the object to be recognized increases, to prevent image overexposure, the exposure time of the recognition device may be decreased to ensure that the average background grayscale of the image is within the second grayscale range. This avoids excessively bright images and loss of detail caused by excessively strong ambient light. Moreover, since decreasing the exposure time mainly reduces the background brightness of the image, which will also reduce the grayscale of the object's face, the intensity of the infrared light emitted may be increased accordingly to compensate for the grayscale of the object's face, ensuring that the grayscale of the object's face is within the first grayscale range, making the brightness and contrast of the object's face in the captured image sufficiently high, thereby enhancing recognition effectiveness.

At the same time, conversely, when the ambient light intensity decreases, the recognition device may increase the exposure time to capture sufficient light, ensuring that the average background grayscale of the image is within the second grayscale range. Moreover, to avoid excessive compensation leading to an overly bright object face under low light conditions, the intensity of the infrared light emitted may also be decreased, ensuring that the grayscale of the object's face is within the first grayscale range, thereby obtaining a clear image under low light conditions while reducing imaging differences under different lighting conditions.

This dynamic adjustment mechanism may effectively balance the brightness and detail of the image, ensuring the accuracy and reliability of the recognition system while avoiding leakage of sensitive background information.

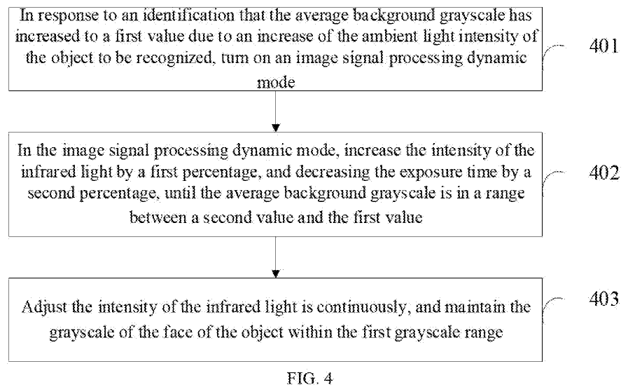

Referring to FIG. 4, in some embodiments, step 301 includes but is not limited to including steps 401 to 403.
Step 401: In response to an identification that the average background grayscale has increased to a first value due to an increase of the ambient light intensity of the object to be recognized, an image signal processing dynamic mode is turned on.
Step 402: In the image signal processing dynamic mode, the intensity of the infrared light is increased by a first percentage, and the exposure time is decreased by a second percentage, until the average background grayscale is in a range between a second value and the first value, where the second value is less than the first value, and the second grayscale range includes the first value and the second value.
Step 403: the intensity of the infrared light is continuously adjusted, and the grayscale of the face of the object is maintained within the first grayscale range.

In this embodiment, when it is detected that the ambient light intensity of the object to be recognized increases, causing the average background grayscale to rise to a preset threshold (referred to herein as the first value), the recognition device may switch to an image signal processing dynamic mode. The image signal processing dynamic mode may be a mode in which exposure time and infrared light intensity are dynamically adjusted based on ambient light intensity. It may be understood that when the recognition device exits the image signal processing dynamic mode, exposure time and infrared light intensity are no longer dynamically adjusted.

After being in the image signal processing dynamic mode, the recognition device may dynamically adjust the infrared light intensity and the exposure time. Specifically, the exposure time may be decreased by a preset percentage (denoted by a second percentage) to prevent image overexposure, and the infrared light intensity may be increased by another preset percentage (denoted by a first percentage) to ensure sufficient brightness and contrast of the object's face in the image. The average background grayscale is controlled within a reasonable range, i.e., between the second value and the first value. The second value is a grayscale lower than the first value. This ensures that the background grayscale is neither too high nor too low, remaining within an appropriate range, which may be referred to as the second grayscale range or may be included within the second grayscale range, ensuring that the background elements of the captured image cannot be recognized by human eyes. Among them, to maintain the brightness of the recognized object unchanged while the background brightness changes, if one changes (increases), the other will be adjusted back. For example, if the first percentage of increase in infrared light intensity is represented by M %, then the second percentage N % of decrease in exposure time may be:

$$N \% = 1 - \frac{1}{1 + M \%} ,$$

which may be transformed into: M %−N %=M %×N %, so M % is greater than N %. The first percentage is greater than the second percentage.

After the average background grayscale is controlled within the second grayscale range, the recognition device may further adjust the infrared light intensity to ensure that the grayscale of the face of the object to be recognized remains within the first grayscale range. The first grayscale range may be preset based on the characteristics of the recognized object and recognition requirements, ensuring that the brightness and details of the face region remain consistent under different lighting conditions, thereby improving the accuracy and reliability of image recognition.

By dynamically adjusting image processing parameters based on changes in ambient light intensity, image quality and recognition effectiveness may be kept stable under different lighting conditions, improving the adaptability and flexibility of the system.

It may be understood that the first value, the second value, and the first grayscale range may be calibrated or obtained through adaptive learning. In some embodiments, the first value is set to 50, the second value is set to 10, and the first grayscale range is set to [110, 160].

Specifically, when the average background grayscale rises to 50 due to an increase in ambient light intensity, the recognition device may activate the image signal processing dynamic mode, increasing the infrared light intensity by a first percentage and decreasing the exposure time by a second percentage to control the average background grayscale between 10 and 50 (the second value and the first value). Further, the recognition device may continue to adjust the infrared light intensity to ensure that the grayscale of the object's face remains within the interval [110, 160].

It may be understood that by controlling the average background grayscale within the range [10, 50], since the grayscale is below 50, background details are severely lost, making it impossible to recognize object contours, thereby avoiding leakage of sensitive background information and reducing background interference with the foreground object. The grayscale range [110, 160] ensures that the brightness of the face region is moderate, neither too bright causing loss of detail nor too dark affecting feature extraction, facilitating more accurate recognition of key facial features such as contours, eyes, nose, and mouth.

Among them, the first value may be any value within the range (10, 50]. In some embodiments, the first value may also be set to 20, the second value set to 10, and the first grayscale range set to [110, 160].

Specifically, when the average background grayscale rises to 20 due to an increase in ambient light intensity, the recognition device may activate the image signal processing dynamic mode, increasing the infrared light intensity by a first percentage and decreasing the exposure time by a second percentage to control the average background grayscale between 10 and 20 (the second value and the first value). Further, the recognition device may continue to adjust the infrared light intensity to ensure that the grayscale of the object's face remains within the range [110, 160].

It may be understood that by controlling the average background grayscale within the range [10, 20], by adjusting the maximum value of the average background grayscale to 20, the discernibility of background details in the captured image is further reduced, i.e., background information leakage is further reduced.

In some embodiments, in response to the ambient light intensity of the object to be recognized decreasing, the intensity of the infrared light emitted by the infrared light is decreased, and the exposure time of the recognition device is increased includes:

in response to the average background grayscale of the object image decreasing to the second value due to the decrease in the ambient light intensity of the object to be recognized after the image signal processing dynamic mode is turned on, the exposure time is increased by the first percentage, and the intensity of the infrared light is decreased by the second percentage, and the average background grayscale is between the second value and the first value.

In this embodiment, when the recognition device is in the image signal processing dynamic mode, and a further decrease in ambient light intensity causes the average background grayscale of the object image to drop to the preset second value, based on the previous increase in infrared light intensity by the first percentage and decrease in exposure time by the second percentage when ambient light intensity increased, here the exposure time is increased by the first percentage, and the infrared light intensity is decreased by the second percentage, to readjust the average background grayscale to be between the second value and the first value. Among them, since the brightness of the face of the object to be recognized is mainly provided by the infrared light, increasing the exposure time may only compensate for the insufficiency of the background grayscale to a certain extent. Therefore, when an increase in background brightness is needed, a larger first percentage may be chosen for the increase adjustment to increase the background grayscale more quickly, while the infrared light intensity is decreased by a smaller second percentage to avoid insufficient brightness of the face of the object to be recognized. That is, the average background grayscale may be increased while maintaining the grayscale of the face of the object to be recognized.

In some embodiments, after decreasing the intensity of the infrared light emitted by the infrared light and increasing the exposure time of the recognition device in response to the ambient light intensity of the object to be recognized decreasing, the image recognition method further includes:

In response to a determination that the intensity of the infrared light decreases to less than a calibrated infrared light intensity, the exposure time is restored to a calibrated exposure time, and the intensity of the infrared light is restored to the calibrated infrared light intensity.

In this embodiment, the calibrated exposure time may be a preset exposure time of the camera.

The calibrated infrared light intensity may refer to a preset light intensity value of the infrared light source determined through a series of experiments and calculations, and may also be understood as the minimum light intensity value at which the foreground of infrared capture may normally recognize facial information.

When the ambient light intensity decreases, the recognition device may decrease the intensity of the infrared light emitted by the infrared light and increase the exposure time of the recognition device to ensure image consistency. However, if the infrared light intensity decreases below the calibrated infrared light intensity, it means that the ambient light intensity is too low at this time, affecting the brightness and details of the image, leading to the inability to normally recognize facial information. At this point, the image signal processing dynamic mode may be exited, the exposure time restored to the calibrated exposure time, and the infrared light intensity restored to the calibrated infrared light intensity.

When dynamically adjusting parameters based on changes in ambient light intensity causes infrared capture to go beyond the normal operating range, the parameters may be restored to calibrated values to avoid degradation of image quality and recognition effectiveness.

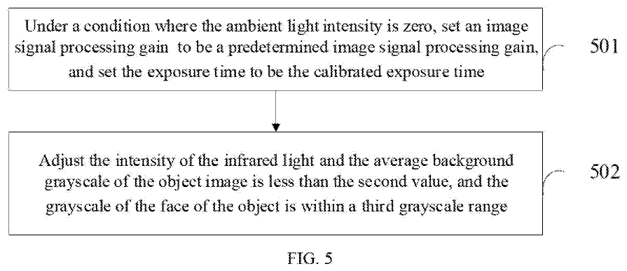

In some embodiments, referring to FIG. 5, the presetting of the calibrated infrared light intensity includes but is not limited to steps 501 to 502.
Step 501: Under a condition where the ambient light intensity is zero, an image signal processing gain is set to be a predetermined image signal processing gain, and the exposure time is set to be the calibrated exposure time.
Step 502: the intensity of the infrared light is adjusted and the average background grayscale of the object image is less than the second value, and the grayscale of the face of the object is within a third grayscale range, where the third grayscale range includes the first grayscale range.

In this embodiment, when the ambient light intensity is zero, it means there is no natural light or other external light sources, and the brightness of the image depends entirely on the infrared light source and the camera settings. The predetermined image signal processing gain may be a gain value used to provide sufficient image brightness under no-light conditions. A higher gain value makes the image brighter but may increase noise. The calibrated exposure time may also be an exposure time used to provide appropriate image brightness under no-light conditions.

Furthermore, the recognition device may adjust the intensity of the infrared light so that the average background grayscale of the object image is less than the second value, while ensuring that the grayscale of the face of the object is within the third grayscale range. Among them, the average background grayscale being less than the second value is to distinguish it from the second grayscale range [second value, first value] in the image signal processing dynamic mode. That is, the calibrated infrared light intensity is set as low as possible, increasing the difference between the dynamically adjusted infrared light intensity and the calibrated infrared light intensity in the image signal processing dynamic mode, preventing the image signal processing dynamic mode from exiting or being activated too frequently. The third grayscale range is a wider range that includes the first grayscale range, capable of covering the grayscales of faces of different types of objects to be recognized under no-light and only infrared light illumination. The recognition device can optimize the brightness and contrast of the image under no-light conditions, ensuring that the background cannot be recognized by human eyes while keeping the details of the object's face clearly visible, thereby improving the accuracy and reliability of recognition.

In some embodiments, the predetermined image signal processing gain is 1, the calibrated exposure time is Ims, the third grayscale range is [90, 180], and the first grayscale range is [110, 160].

Specifically, the predetermined image signal processing gain is set to 1 means no additional gain or attenuation is applied to the image signal, ensuring that the original brightness and contrast of the image are preserved. Different objects to be recognized (such as pets with different coat colors, people with different skin tones) have different reflectivity under infrared light illumination. A wider grayscale range may ensure that the grayscales of faces of these differently reflective objects under infrared light illumination are covered. For example, a pet with dark fur may reflect less infrared light, while a pet with light fur may reflect more infrared light. By setting the grayscale range to [90, 180], it may be ensured that these differently reflective objects may be accurately recognized under no-light conditions.

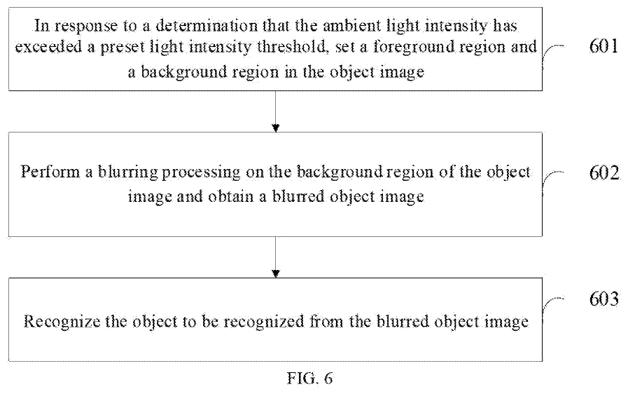

In some embodiments, referring to FIG. 6, the schematic flowchart of object image recognition may include but is not limited to steps 601 to 603:
Step 601: In response to a determination that the ambient light intensity has exceeded a preset light intensity threshold, a foreground region and a background region are set in the object image.
Step 602: A blurring processing is performed on the background region of the object image and a blurred object image is obtained.
Step 603: the object to be recognized from the blurred object image is recognized.

In this embodiment, the preset light intensity threshold may be a set value for ambient light. When the ambient light intensity reaches this set value, it indicates that the current ambient light is strong light, which may also be understood as a situation where the average background grayscale may not be kept within the second grayscale range by adjusting the exposure parameters of the recognition device and the infrared light intensity.

The foreground region may refer to the part of the image including a main object or an object of interest. The foreground region includes the image of the face of the object to be recognized. That is, the foreground region may be the region where the facial features of the object to be recognized are located, which may be located by a target detection algorithm.

The background region may refer to the part of the image that does not include the main object or the object of interest. Here, the background region is the part of the object image excluding the foreground region (such as the face).

Blurring processing may refer to reducing details and distractions in the background to make the foreground object more prominent. Here, blurring the background region may highlight the face in the foreground region while also blurring elements that may include sensitive information such as room layouts and people moving around in the background, thereby avoiding privacy leakage. When performing image recognition, recognition may be performed on the blurred object image, improving recognition accuracy and efficiency while protecting privacy.

In some embodiments, the recognition device performs blurring processing on the background region in the object image and obtains a blurred object image includes: the recognition device performs the blurring adjustment of image parameters on the background region of the object image and obtains the blurred object image, where the image parameters include at least one of: de-texturing, down-sampling, blur kernel, contrast, quantization bit width, dynamic range compression, privacy mask, occlusion, tone mapping, gamma, sharpness, and noise reduction.

In this embodiment, these image processing parameter adjustments may be used alone or in combination to achieve the best blurring effect. For example, de-texturing may be implemented using Gaussian blur or median filtering to remove textural details from the background, making the background appear smoother.

Down-sampling reduces the resolution of the image to reduce background details, making the background appear more blurred.

The use of blur kernels, such as Gaussian blur kernels or mean blur kernels, allows for different degrees of blurring of the background as needed.

Contrast adjustment may reduce the difference between light and dark areas in the background by changing the histogram of the image, making the background softer.

Reducing the quantization bit width may reduce image details, further blurring the background.

Dynamic range compression adjusts the histogram of the image to reduce the difference between light and dark areas in the background, making the background appear more uniform. Adding a privacy mask can apply blur or mosaic effects to the background, protecting

private information.

Occlusion reduces the visibility of the background by adding virtual occlusions, such as curtains or plants, to the background.

Tone mapping and gamma adjustment may change the hue and brightness of the image, making the background appear softer.

Reducing sharpness and applying noise reduction may reduce the sharpness and noise in the background, making it smoother.

In some embodiments, the recognition device performs blurring processing on the background region of the object image and obtains a blurred object image includes: the recognition device performs blurring processing on the background region of the object image by using a component of the recognition device to obtain the blurred object image. The element includes but is not limited to a variable aperture, a switchable or continuously adjustable neutral density filter, a controllable defocus element, and polarization control.

In this embodiment, in addition to blurring the background region through post-image processing, the background may also be blurred directly during capture.

The variable aperture is the component of a camera lens. By adjusting the size of the aperture, the amount of light entering the lens can be controlled, thereby affecting the depth of field. A larger aperture produces a shallower depth of field, making the background more blurred, thus highlighting the foreground object.

Additionally, a switchable or continuously adjustable neutral density filter may also be used for blurring processing. A neutral density filter reduces the amount of light entering the lens, allowing for a larger aperture while controlling exposure, thereby achieving a background blur effect.

A controllable defocus element is an optical element that may adjust the focal length and degree of blurring, such as a liquid lens, a phase modulator, a deformable mirror, or a focusing mechanism. By adjusting its position or parameters, the degree of background blurring may be precisely controlled.

A polarizing filter (including cross-polarization: where the angle between the light source linear polarization and the camera polarizer is approximately 90°, and other polarization state control) may improve image contrast and saturation by reducing reflected and scattered light. By controlling the polarization direction of light, it may also indirectly affect the background blurring effect.

These optical and physical methods may be used alone or in combination to achieve the best blurring effect, not only reducing background details and distractions and highlighting the foreground object but also protecting privacy to a certain extent by preventing leakage of sensitive information in the background.

In some embodiments, after recognizing the object to be recognized from the object image, the method further includes:
a sequence of object images of the object to be recognized is saved to a server.

In this embodiment, after adjusting the intensity of the infrared light emitted by the infrared light and the exposure parameters of the recognition device, the recognition device may also capture a series of images of the object to be recognized, i.e., a sequence of object images. These image sequences are captured under optimized settings of infrared light intensity and exposure parameters and may maintain image consistency under different lighting conditions while avoiding background privacy leakage. The recognition device may save the sequence of object images to a server, which serves as a centralized data storage and management platform, ensuring the security, integrity, and accessibility of the image data. By saving the object images on the server, associated devices may access the sequence of object images in the server through a data access interface. This means that users' personal devices, such as mobile phones, tablets, or computers, as well as other viewing devices, may retrieve these image sequences from the server for viewing.

The viewing methods include not only viewing static photos but also watching historical video clips and real-time footage. Specifically, users may access static photos on the server through associated devices. These photos are images captured at specific moments and may provide detailed information instantaneously. At the same time, users may watch historical video clips, which are composed of a series of continuous historical object images and may show the dynamic changes of the object to be recognized over a period. In addition, the system supports real-time playback, allowing users to view real-time images captured by the camera through associated devices, thereby obtaining immediate visual information.

It may be understood that the sequence of object images may also be a sequence of images after blurring processing of the background region, highlighting the main object in the foreground while protecting privacy information; it may also be a sequence of images formed by cropping the foreground region from the object image. By precisely locating and cropping the foreground region, a sequence of images including only the foreground region may be created, eliminating background interference while further reducing exposure of background elements.

The image recognition method of the embodiment of the present application is described below with an example.

In the absence of visible light, the recognition device calibrates the default parameters of the camera ISP, with the ISP gain fixed at 1, the exposure time fixed at Ims, the infrared light intensity is adjusted to keep the average background grayscale does not exceed 10, and within the depth of field of infrared capture, the average grayscale of the pet's face is at least 90 and does not exceed 180, the calibrated infrared light intensity A is determined. At this time, the processing mode of the recognition device may be referred to as the normal mode.

During pet recognition, continuously detect the average background grayscale. After the average background grayscale exceeds 20, the recognition device enters the image signal processing dynamic mode, starts decreasing the exposure time by a second percentage and increasing the infrared light intensity by a first percentage until the average background grayscale is below 20 and above 10. In the image signal processing dynamic mode, when a pet's face is detected, adjust (increase or decrease) the infrared light intensity according to the average grayscale of the pet's face so that the average grayscale of the pet's face is controlled between 110 and 160.

In the image signal processing dynamic mode, when the average background grayscale falls below 10, the exposure time starts increasing by a first percentage and decreasing the infrared light intensity by a second percentage until the average background grayscale is below 20 and above 10. If during this period the infrared light intensity falls below the calibrated infrared light intensity A, the recognition device switches from the image signal processing dynamic mode to the normal mode, i.e., the exposure time is restored to 1 ms, and the infrared light intensity is restored to the calibrated infrared light intensity A.

The embodiments of the present application adopt infrared technology for pet recognition, especially using infrared illumination under all-weather conditions, which may avoid color imaging deviations caused by different lighting conditions and maintain image consistency. Infrared technology may adapt to various lighting conditions, including daylight, strong light, and backlight situations. That is, by equipping the active infrared camera with a narrow-band infrared filter, it may filter out most bands of infrared light, so that the small amount of infrared light in visible light does not significantly affect imaging. This may avoid the problem of decreased pet recognition accuracy due to large differences in image brightness caused by insufficient or excessive light when using full-color imaging. In addition, using light fill light at night (e.g., RGB fill lights may produce multiple colors, and by adjusting the brightness ratio of red, green, and blue, any color temperature from cool to warm light may be achieved) to avoid insufficient light at night, pets or users may feel uncomfortable with sudden light, while infrared technology may effectively avoid these problems.

The embodiments of the present application use a single-band infrared light source. Regardless of whether there is visible light in the environment, background elements other than the pet in the maintained image cannot be recognized by human eyes, protecting user privacy. It also ensures that the average brightness of the pet's face may be maintained within a reasonable range with or without visible light. For pets with dark fur, darker images of the fur may be obtained; for pets with light fur, brighter images of the fur may be obtained. By comparing with images already stored in the library, the target pet may be accurately recognized without the recognition result being disturbed by the pet's fur color or texture, providing users with an accurate and stable pet recognition method.

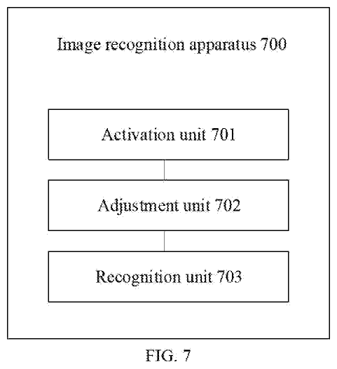

Referring to FIG. 7, FIG. 7 is a schematic structural diagram of an image recognition apparatus according to the present application. The image recognition apparatus 700 includes an infrared light and a camera, where a filter wavelength range of the camera includes an infrared wavelength range. The apparatus 700 includes:
an activation unit 701, configured to turn on the infrared light;
an adjustment unit 702, configured to, in response to a determination that an ambient light intensity of an object to be recognized is changed in a first direction, control an intensity of infrared light emitted by the infrared light to change in the first direction, control an exposure parameter of the recognition device to change in a second direction, maintain a grayscale of an object face in an object image captured by the recognition device within a first grayscale range, and maintain an average background grayscale of the object image within a second grayscale range, where the second direction is opposite to the first direction, and grayscales of the second grayscale range beingless than a lower limit of a preset grayscale threshold recognizable by human eyes; and
a recognition unit 703, configured to recognize the object to be recognized from the object image.

In at least one embodiment, in one embodiment, the exposure parameter is an exposure time;
the adjustment unit 702 includes:
a first adjustment subunit, configured to, i in response to a determination that the ambient light intensity of the object to be recognized has increased, increase the intensity of the infrared light emitted by the infrared light, and decrease the exposure time of the recognition device; and
a second adjustment subunit, configured to, in response to a determination that the ambient light intensity of the object to be recognized has decreased, decrease the intensity of the infrared light emitted by the infrared light, and increase the exposure time of the recognition device.

In at least one embodiment, in one embodiment, the first adjustment subunit includes:
an activation module, configured to, in response to in response to an identification that the average background grayscale has increased to a first value due to an increase of the ambient light intensity of the object to be recognized, turn on an image signal processing dynamic mode;
a first adjustment module, configured to, in the image signal processing dynamic mode, increasing the intensity of the infrared light by a first percentage, and decrease the exposure time by a second percentage, until the average background grayscale is in a range between a second value and the first value, wherein the second value is less than the first value, and the second grayscale value range comprises the first value and the second value; and a second adjustment module, configured to continue to adjust the intensity of the infrared light and keeping the grayscale of the object face being within the first grayscale value range.

In at least one embodiment, the first value is 50, the second value is 10, and the first grayscale range is [110, 160].

In at least one embodiment, the first value is 20, the second value is 10, and the first grayscale range is [110, 160].

In at least one embodiment, the second adjustment subunit includes:
a third adjustment module, configured to, in response to a determination that the average background grayscale value of the object image has decreased to the second value due to a decrease of the ambient light intensity of the object to be recognized after the image signal processing dynamic mode is turned on, increase the exposure time by the first percentage, and decreasing the intensity of the infrared light by the second percentage, where the average background grayscale is between the second value and the first value.

In at least one embodiment, the adjustment unit 702 further includes:
a restoration subunit, configured to, in response to a determination that the intensity of the infrared light has decreased to less than a calibrated infrared light intensity, restore the exposure time to calibrated exposure time, and restore the intensity of the infrared light to the calibrated infrared light intensity.

In at least one embodiment, the adjustment unit 702 further includes:
a setting subunit, configured to, set an image signal processing gain to a predetermined image signal processing gain and set the exposure time to the calibrated exposure time under a condition that the ambient light intensity is zero; and a third adjustment subunit, configured to adjust the intensity of the infrared light to make the average background grayscale of the object image be less than the second value, and the grayscale of the object face is within a third grayscale value range, where the third grayscale value range comprises the first grayscale value range.

In at least one embodiment, the predetermined image signal processing gain is 1, the calibrated exposure time is Ims, the third grayscale value range is [90, 180], and the first grayscale value range is [110, 160].

In at least one embodiment, the adjustment unit 702 further includes:
a region setting subunit, configured to, in response to a determination that the ambient light intensity has exceeded a preset light intensity threshold, set a foreground region and a background region in the object image, where the foreground region comprises an image of the object face of the object to be recognized; and
a blurring subunit, configured to perform a blurring processing on the background region of the object image and obtaining a blurred object image;
the recognition unit 703 includes:
a recognition subunit, configured to recognize the object to be recognized from the blurred object image.

In at least one embodiment, the blurring subunit includes:
performing a blurring adjustment of image parameters on the background region

of the object image and obtaining the blurred object image, wherein the image parameters comprise at least one of: a de-texturing, a down-sampling, a blur kernel, a contrast, a quantization bit width, a dynamic range compression, a privacy mask, an occlusion, a tone mapping, a gamma, sharpness, and a noise reduction.

In at least one embodiment, the blurring subunit includes:
performing a blurring processing on the background region of the object image using at least one of: a variable aperture, a switchable or continuously adjustable neutral density filter, a controllable defocus element, and polarization control, and obtaining the blurred object image.

In at least one embodiment, in one embodiment, the recognition unit 703 further includes:
saving a sequence of object images of the object to be recognized into a server. An embodiment of the present application further provides an electronic device. The electronic device includes a memory and a processor, wherein the memory stores a computer program, and the processor implements the above image recognition method when executing the computer program. The electronic device may be any intelligent terminal, including a tablet computer, an in-vehicle computer, etc.

Referring to FIG. 8, FIG. 8 illustrates a hardware structure of an electronic device according to another embodiment. The electronic device includes:
a processor 801, which may be implemented by a general-purpose CPU (Central Processing Unit), a microprocessor, an Application Specific Integrated Circuit (ASIC), or one or more integrated circuits, for executing relevant programs to implement the technical solutions provided in the embodiments of the present application;
a storage device 802, which may be implemented in the form of a Read Only Memory (ROM), a static storage device, a dynamic storage device, or a Random Access Memory (RAM). The storage device 802 may store an operating system and other application programs. When the technical solutions provided in the specification are implemented by software or firmware, relevant program codes are stored in the storage device 802 and called by the processor 801 to execute the image recognition method of the embodiments of the present application.
an input/output interface 803, for implementing information input and output.
a communication interface 804, for implementing communication interaction between the device and other devices, which may be implemented by wired means (e.g., USB, network cable, etc.) or wireless means (e.g., mobile network, WIFI, Bluetooth, etc.); and
An infrared light 806, and a camera 807. A filter wavelength range of the camera includes an infrared wavelength range. a bus 807, for transmitting information between various components of the device (e.g., the processor 801, the storage device 802, the input/output interface 803, the communication interface 804, the infrared light 805, and the camera 806).where the processor 801, the storage device 802, the input/output interface 803, the communication interface 804, the infrared light 805, and the camera 806 achieve internal communication connections within the device via the bus 807.

An embodiment of the present application further provides a computer-readable storage medium, wherein the computer-readable storage medium stores a computer program, and the computer program, when executed by a processor, implements the above image recognition method.

As a non-transitory computer-readable storage medium, the memory may be used to store non-transitory software programs and non-transitory computer-executable programs. In addition, the memory may include high-speed random access memory and may also include non-transitory memory, such as at least one magnetic disk storage device, flash memory device, or other non-transitory solid-state storage devices. In some implementations, the memory may In at least one embodiment include memory remotely located relative to the processor, and these remote memories may be connected to the processor via a network. Examples of the above network include, but are not limited to, the Internet, intranets, local area networks, mobile communication networks, and combinations thereof.

The embodiments described in the present application are intended to more clearly illustrate the technical solutions of the embodiments of the present application and do not constitute a limitation on the technical solutions provided in the embodiments of the present application. Those skilled in the art will appreciate that with the evolution of technology and the emergence of new application scenarios, the technical solutions provided in the embodiments of the present application are equally applicable to similar technical problems.

Those skilled in the art can understand that the technical solutions shown in the figures do not constitute a limitation on the embodiments of the present application and may include more or fewer steps than shown, or combine certain steps, or different steps.

The apparatus embodiments described above are merely illustrative, wherein the units described as separate components may or may not be physically separate, i.e., they may be located in one place or distributed over multiple network units. Some or all of the modules may be selected according to actual needs to achieve the objectives of the solutions of the embodiments.

A person of ordinary skill in the art can understand that all or part of the steps in the methods disclosed above, and functional modules/units in systems and devices, may be implemented as software, firmware, hardware, and suitable combinations thereof.

In the specification and claims of the present application and the above-mentioned drawings, the terms “first”, “second”, “third”, “fourth”, etc. (if present) are used to distinguish similar objects and are not necessarily used to describe a specific order or sequence. It should be understood that the data so used may be interchanged under appropriate circumstances so that the embodiments of the present application described herein can be practiced in sequences other than those illustrated or described herein. Furthermore, the terms “comprising” and “having” and any variations thereof are intended to cover non-exclusive inclusion. For example, a process, method, system, product, or device comprising a series of steps or units is not necessarily limited to those steps or units expressly listed but may include other steps or units not expressly listed or inherent to such process, method, product, or device.

It should be understood that in the present application, “at least one item” means one or more, and “multiple” means two or more. “And/or” describes the association relationship of associated objects, indicating that three relationships may exist. For example, “A and/or B” may mean: A exists alone, B exists alone, and A and B exist simultaneously, where A and B may be singular or plural. The character “/” generally indicates that the associated objects before and after are in an “or” relationship. “At least one of the following items” or similar expressions refer to any combination of these items, including any combination of single items or plural items. For example, at least one of a, b, or c may mean: a, b, c, “a and b”, “a and c”, “b and c”, or “a and b and c”, where a, b, c may be single or multiple.

In the several embodiments provided in the present application, it should be understood that the disclosed apparatus and method may be implemented in other ways. For example, the apparatus embodiments described above are merely illustrative. For instance, the division of the above units is only a logical functional division, and there may be other division methods in actual implementation. For example, multiple units or components may be combined or integrated into another system, or some features may be omitted or not implemented. On the other hand, the mutual coupling or direct coupling or communication connection shown or discussed may be through some interfaces, indirect coupling or communication connection of devices or units, which may be electrical, mechanical, or other forms.

The units described as separate components may or may not be physically separate, and the components shown as units may or may not be physical units, i.e., they may be located in one place or distributed over multiple network units. Some or all of the units may be selected according to actual needs to achieve the objectives of the solutions of the embodiments.

In addition, functional units in various embodiments of the present application may be integrated into one processing unit, or each unit may exist physically separately, or two or more units may be integrated into one unit. The integrated units may be implemented in the form of hardware or software functional units.

If the integrated unit is implemented in the form of a software functional unit and sold or used as an independent product, it may be stored in a computer-readable storage medium. Based on such understanding, the technical solution of the present application essentially, or the part contributing to the prior art, or all or part of the technical solution, may be embodied in the form of a software product stored in a storage medium, comprising instructions for causing a computer device (which may be a personal computer, a server, or a network device, etc.) to perform all or part of the steps of the methods of various embodiments of the present application. The aforementioned storage medium includes: a U disk, a removable hard disk, a Read-Only Memory (ROM), a Random Access Memory (RAM), a magnetic disk, or an optical disk, and other media that can store programs.

The preferred embodiments of the present application have been described above with reference to the accompanying drawings, but this does not limit the scope of the claims of the embodiments of the present application. Any modifications, equivalent substitutions, and improvements made by those skilled in the art without departing from the scope and spirit of the embodiments of the present application should fall within the scope of the claims of the embodiments of the present application.

What is claimed is:

1. An image recognition method, applied in an electronic device, which comprises an infrared light and a camera, the image recognition method comprising:
turning on the infrared light;
in response to a determination that an ambient light intensity of an object to be recognized is changed in a first direction, controlling an intensity of infrared light emitted by the infrared light to change in the first direction, controlling an exposure parameter of the camera to change in a second direction, maintaining a grayscale of an object face in an object image captured by the camera within a first grayscale range, and maintaining an average background grayscale of the object image within a second grayscale range, wherein the second direction is opposite to the first direction, and grayscales of the second grayscale range beingless than a lower limit of a preset grayscale threshold recognizable by human eyes; and
recognizing the object to be recognized from the object image.

2. The image recognition method according to claim 1, wherein the exposure parameter comprises exposure time, in response to a determination that the ambient light intensity of the object to be recognized is changed in the first direction, controlling the intensity of infrared light emitted by the infrared light to change in the first direction, and controlling the exposure parameter of the camera to change in the second direction comprises:
in response to a determination that the ambient light intensity of the object to be recognized has increased, increasing the intensity of the infrared light emitted by the infrared light, and decreasing the exposure time of the camera; and
in response to a determination that the ambient light intensity of the object to be recognized has decreased, decreasing the intensity of the infrared light emitted by the infrared light, and increasing the exposure time of the camera.

3. The image recognition method according to claim 2, wherein in response to the ambient light intensity of the object to be recognized increasing, increasing the intensity of the infrared light emitted by the infrared light, and decreasing the exposure time of the camera comprises:
in response to an identification that the average background grayscale has increased to a first value due to an increase of the ambient light intensity of the object to be recognized, turning on an image signal processing dynamic mode;
in the image signal processing dynamic mode, increasing the intensity of the infrared light by a first percentage, and decreasing the exposure time by a second percentage, until the average background grayscale is in a range between a second value and the first value, wherein the second value is less than the first value, and the second grayscale value range comprises the first value and the second value; and
continuing adjusting the intensity of the infrared light and keeping the grayscale of the object face being within the first grayscale value range.

4. The image recognition method according to claim 3, wherein in response to a determination that the ambient light intensity of the object to be recognized has decreased, decreasing the intensity of the infrared light emitted by the infrared light, and increasing the exposure time of the camera comprises:
in response to a determination that the average background grayscale value of the object image has decreased to the second value due to a decrease of the ambient light intensity of the object to be recognized after the image signal processing dynamic mode is turned on, increasing the exposure time by the first percentage, and decreasing the intensity of the infrared light by the second percentage, wherein the average background grayscale is between the second value and the first value.

5. The image recognition method according to claim 2, wherein in response to a determination that the ambient light intensity of the object to be recognized has decreased, after decreasing the intensity of the infrared light emitted by the infrared light, and increasing the exposure time of the camera, the method further comprises:
in response to a determination that the intensity of the infrared light has decreased to less than a calibrated infrared light intensity, restoring the exposure time to calibrated exposure time, and restoring the intensity of the infrared light to the calibrated infrared light intensity.

6. The image recognition method according to claim 5, wherein the calibrated infrared light intensity is preset by:
setting an image signal processing gain to a predetermined image signal processing gain and setting the exposure time to the calibrated exposure time under a condition that the ambient light intensity is zero; and
adjusting the intensity of the infrared light to make the average background grayscale of the object image be less than the second value, and the grayscale of the object face is within a third grayscale value range, wherein the third grayscale value range comprises the first grayscale value range.

7. An electronic device comprising:
an infrared light;
a camera;
a storage device;
at least one processor; and
the storage device storing one or more programs that, when executed by the at least one processor, cause the at least one processor to:
turn on the infrared light;
in response to a determination that an ambient light intensity of an object to be recognized is changed in a first direction, control an intensity of infrared light emitted by the infrared light to change in the first direction, control an exposure parameter of the camera to change in a second direction, maintain a grayscale of an object face in an object image captured by the camera within a first grayscale range, and maintain an average background grayscale of the object image within a second grayscale range, wherein the second direction is opposite to the first direction, and grayscales of the second grayscale range beingless than a lower limit of a preset grayscale threshold recognizable by human eyes; and
recognize the object to be recognized from the object image.

8. The electronic device according to claim 7, wherein the exposure parameter comprises exposure time, in response to a determination that the ambient light intensity of the object to be recognized is changed in the first direction, the at least one processor controls the intensity of infrared light emitted by the infrared light to change in the first direction, and controls the exposure parameter of the camera to change in the second direction by:
in response to a determination that the ambient light intensity of the object to be recognized has increased, increasing the intensity of the infrared light emitted by the infrared light, and decreasing the exposure time of the camera; and
in response to a determination that the ambient light intensity of the object to be recognized has decreased, decreasing the intensity of the infrared light emitted by the infrared light, and increasing the exposure time of the camera.

9. The electronic device according to claim 8, wherein in response to the ambient light intensity of the object to be recognized increasing, the at least one processor increases the intensity of the infrared light emitted by the infrared light, and decreasing the exposure time of the camera by:
in response to an identification that the average background grayscale has increased to a first value due to an increase of the ambient light intensity of the object to be recognized, turning on an image signal processing dynamic mode;
in the image signal processing dynamic mode, increasing the intensity of the infrared light by a first percentage, and decreasing the exposure time by a second percentage, until the average background grayscale is in a range between a second value and the first value, wherein the second value is less than the first value, and the second grayscale value range comprises the first value and the second value; and
continuing adjusting the intensity of the infrared light and keeping the grayscale of the object face being within the first grayscale value range.

10. The electronic device according to claim 9, wherein the first value is 50, the second value is 10, and the first grayscale value range is [110, 160].

11. The electronic device according to claim 9, wherein the first value is 20, the second value is 10, and the first grayscale value range is [110, 160].

12. The electronic device according to claim 9, wherein in response to a determination that the ambient light intensity of the object to be recognized has decreased, the at least one processor decreases the intensity of the infrared light emitted by the infrared light, and increasing the exposure time of the camera by:
in response to a determination that the average background grayscale value of the object image has decreased to the second value due to a decrease of the ambient light intensity of the object to be recognized after the image signal processing dynamic mode is turned on, increasing the exposure time by the first percentage, and decreasing the intensity of the infrared light by the second percentage, wherein the average background grayscale is between the second value and the first value.

13. The electronic device according to claim 9, wherein in response to a determination that the ambient light intensity of the object to be recognized has decreased, after the at least one processor decreases the intensity of the infrared light emitted by the infrared light, and increases the exposure time of the camera, the at least one processor is further caused to:
in response to a determination that the intensity of the infrared light has decreased to less than a calibrated infrared light intensity, restore the exposure time to calibrated exposure time, and restore the intensity of the infrared light to the calibrated infrared light intensity.

14. The electronic device according to claim 7, wherein the calibrated infrared light intensity is preset by:
setting an image signal processing gain to a predetermined image signal processing gain and setting the exposure time to the calibrated exposure time under a condition that the ambient light intensity is zero; and
adjusting the intensity of the infrared light to make the average background grayscale of the object image be less than the second value, and the grayscale of the object face is within a third grayscale value range, wherein the third grayscale value range comprises the first grayscale value range.

15. The electronic device according to claim 14, wherein the predetermined image signal processing gain is 1, the calibrated exposure time is Ims, the third grayscale value range is [90, 180], and the first grayscale value range is [110, 160].

16. The electronic device according to claim 7, wherein before the at least one processor recognizes the object to be recognized from the object image, the at least one processor is further caused to:
in response to a determination that the ambient light intensity has exceeded a preset light intensity threshold, set a foreground region and a background region in the object image, wherein the foreground region comprises an image of the object face of the object to be recognized; and
perform a blurring processing on the background region of the object image and obtain a blurred object image;
wherein the at least one processor recognizes the object to be recognized from the object image by:
recognizing the object to be recognized from the blurred object image.

17. The electronic device according to claim 9, wherein the at least one processor performs a blurring processing on the background region of the object image and obtaining the blurred object image by:
performing a blurring adjustment of image parameters on the background region of the object image and obtaining the blurred object image, wherein the image parameters comprise at least one of: a de-texturing, a down-sampling, a blur kernel, a contrast, a quantization bit width, a dynamic range compression, a privacy mask, an occlusion, a tone mapping, a gamma, sharpness, and a noise reduction.

18. The electronic device according to claim 9, wherein performing a blurring processing on the background region of the object image and obtaining the blurred object image by:
performing a blurring processing on the background region of the object image using at least one of: a variable aperture, a switchable or continuously adjustable neutral density filter, a controllable defocus element, and polarization control, and obtaining the blurred object image.

19. The electronic device according to claim 7, wherein after the at least one processor recognizes the object to be recognized from the object image, the at least one processor is further caused to:
save a sequence of object images of the object to be recognized into a server.

20. A non-transitory storage medium having instructions stored thereon, when the instructions are executed by a processor of an electronic device, the electronic device comprises an infrared light and a camera, the processor is caused to perform an image recognition method, wherein the image recognition method comprises:
turning on an infrared light;
in response to a determination that an ambient light intensity of an object to be recognized is changed in a first direction, controlling an intensity of infrared light emitted by the infrared light to change in the first direction, controlling an exposure parameter of the camera to change in a second direction, maintaining a grayscale of an object face in an object image captured by the camera within a first grayscale range, and maintaining an average background grayscale of the object image within a second grayscale range, wherein the second direction is opposite to the first direction, and grayscales of the second grayscale range beingless than a lower limit of a preset grayscale threshold recognizable by human eyes; and
recognizing the object to be recognized from the object image.
